(19) United States
(12) Patent Application Publication
(10) Pub. No.: US 2024/0352777 A1
(43) Pub. Date: Oct. 24, 2024

(54) HINGE ASSEMBLY

(71) Applicant: LATCH ADVANTAGE, LLC, Deerfield Beach, FL (US)

(72) Inventor: AUDRIUS MACERNIS, VICTORIA (AU)

(21) Appl. No.: 18/138,149

(22) Filed: Apr. 24, 2023

(51) Int. Cl. E05F 3/20

(52) U.S. Cl. CPC E05F 3/20; E05Y 2900/40

(57) ABSTRACT

Disclosed herein is an improved hinge assembly for providing soft-closing functionality in a gate. The hinge assembly comprises a mounting element having a top sleeve and a bottom sleeve to receive an elongated hollow cylinder. An actuator is provided on the outer surface of the elongated hollow cylinder. A spring and a tension screw are adapted within the elongated hollow cylinder. The spring is adjusted using the tension screw for altering spring tension, wherein the actuator absorbs an impact of the altering spring tension to thereby facilitate the soft-closing functionality while closing the gate.

### FIELD OF THE DISCLOSURE

The present invention relates to improvements in hinges, and is particularly, though not exclusively, applicable to hinges for self-closing gates and doors.

### BACKGROUND OF THE DISCLOSURE

Self-closing (and self-opening) gates are in common use, particularly in situations which require increased safety. For example, it is mandatory in some countries to provide self-closing gates for swimming pool fences, to prevent unsupervised access by small children if other persons have forgotten to close the gate. Similarly, self-closing gates are often employed in households to prevent toddlers from accessing stairways and other potentially hazardous areas. Gates of this type generally include a helical spring-loaded hinge which produces a torque to bias the hinge towards the closed (or open, as the case may be) position.

A problem which arises in relation to such gates is that they vary in dimension and weight, and so the spring tension in the hinge must be adjusted accordingly to have the gate close or open at an appropriate speed. One solution to the problem, as proposed by Australian patent no. AU 666491, is to provide a coupling element connected to the spring. The coupling element includes a head portion with a circular top section and a hexagonal intermediate section which engages a matching hexagonal engagement surface in an aperture of the spring housing. The top section includes a slot to accommodate a screwdriver. When it is desired to adjust the spring tension, the person installing the gate inserts a screwdriver into the slot and applies pressure to disengage the coupling element so that it can be turned to a different orientation. A disadvantage of this arrangement is that it requires the simultaneous application of a linear force along the spring axis and a rotational force about the spring axis. This is a relatively unnatural movement which can cause inconvenience to the installer. The use of a screwdriver can also cause inconvenience in that the knuckles on the installer's hand may be obstructed by the hinge or the gate to which it is mounted.

It is therefore desirable to provide a hinge which has adjustable tension but is easier to install and adjust than known hinges of the type described above. It is also desirable to provide a hinge assembly that can be installed on the gates to provide soft closing functionality.

### SUMMARY

The present invention provides an improved hinge assembly for providing soft-closing functionality in a gate, the hinge assembly comprising: a mounting clement having a top sleeve and a bottom sleeve to receive an elongated hollow cylinder; an actuator provided on an outer surface of the elongated hollow cylinder; a spring and a tension screw adapted within the elongated hollow cylinder, the spring is adapted to be adjusted using the tension screw for altering spring tension; wherein the actuator absorbs an impact of the altering spring tension to thereby facilitate the soft-closing functionality while closing the gate.

According to an embodiment of the present subject matter, the actuator of the elongated cylinder is a ‘D’ shaped three-dimensional structure fixed on one side of the outside surface of the elongated hollow cylinder.

According to an embodiment of the present subject matter, the actuator rests on a slit provided on one side of the mounting element.

According to an embodiment of the present subject matter, the actuator rests on a slit provided on one leaf of the pair of hinge leaves of the mounting element.

According to an embodiment of the present subject matter, the mounting element comprises a pair of hinge leaves that can be mounted on the gate and a corresponding gate post, the pair of hinge leaves move rotatably between an open position and a closed position to thereby open and close the gate.

According to an embodiment of the present subject matter, the hinge assembly further comprising a top cap and a bottom cap.

According to an embodiment of the present subject matter, the the top cap is adapted to engage a first end of the spring and a second end of the spring is engaged with one end of the tension screw.

According to an embodiment of the present subject matter, the top cap is adapted to provide an easy grip and is rotated to rotate the tension screw for adjusting the tension.

According to an embodiment of the present subject matter, the elongated hollow cylinder is installed on the mounting element by using the top cap adapted over the spring and the bottom cap adapted below another end of the tension screw.

According to an embodiment of the present subject matter, the top cap passes through the top sleeve and the bottom cap passes through the bottom sleeve to install the elongated hollow cylinder with the mounting element.

Other objects and advantages of the embodiments herein will become readily apparent from the following detailed description taken in conjunction with the accompanying drawings.

### BRIEF DESCRIPTION OF THE DRAWING

Preferred embodiments of the invention will now be described by way of non-limiting examples only by reference to the accompanying drawings, in which:

FIG. 1, according to an embodiment of the present invention, is an exploded view of the hinge assembly.

FIG. 2, according to an embodiment of the present invention, is another exploded view of the hinge assembly.

FIG. 3, according to an embodiment of the present invention, is another exploded view of the hinge assembly, also illustrating a pair of hinge leaves.

FIG. 4, according to an embodiment of the present invention, is another exploded view of the hinge assembly, also illustrating the pair of hinge leaves.

Like reference numerals refer to like parts throughout the description of several views of the drawings.

### FIGURES REFERENCE NUMERAL

10 Top Cap
20 Engaging part of spring
30 Spring
40 Tension Screw
50 Bottom Part Of Tension Screw
60 Elongated Hollow Cylinder
70 Actuator
80 Top Sleeve
90 Bottom Cap
100 Hinge Assembly
110 Mounting Element
120 Fastening Means
130 Bottom Sleeve
140 Fixing Means
150 First Hinge Leaf
160 Second Hinge Leaf

### DESCRIPTION OF PREFERRED EMBODIMENT

This section is intended to provide an explanation and description of various possible embodiments of the present invention. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practised and to further enable the person skilled in the art to practice the embodiments used herein. Also, the examples/embodiments described herein should not be construed as limiting the scope of the embodiments herein. Corresponding reference numerals indicate corresponding parts throughout the drawings.

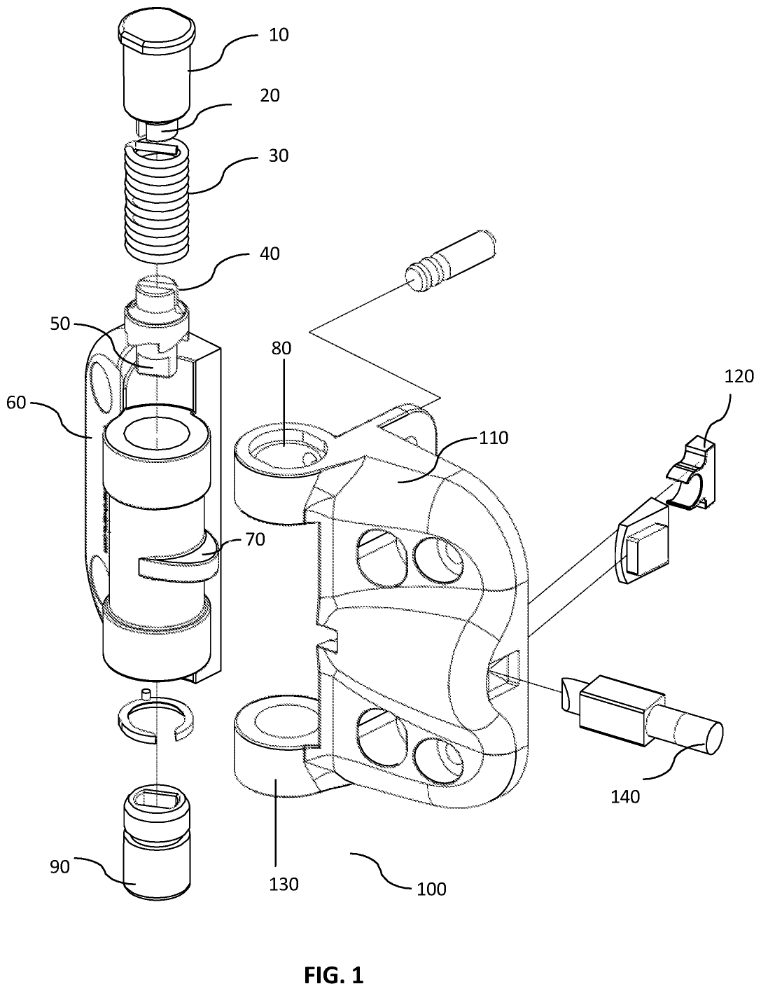

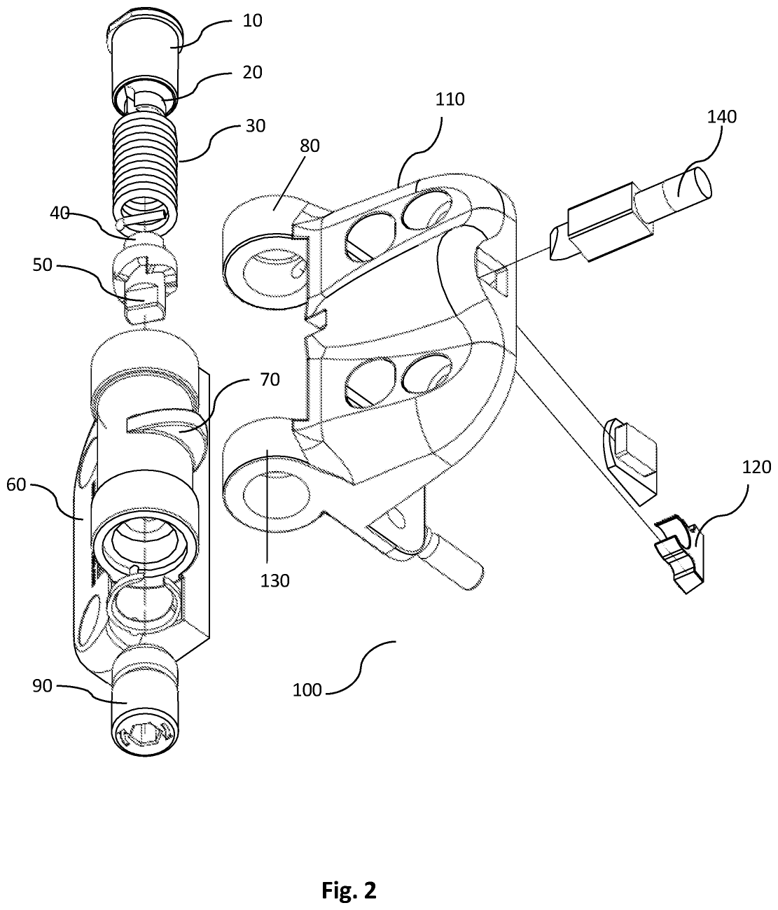

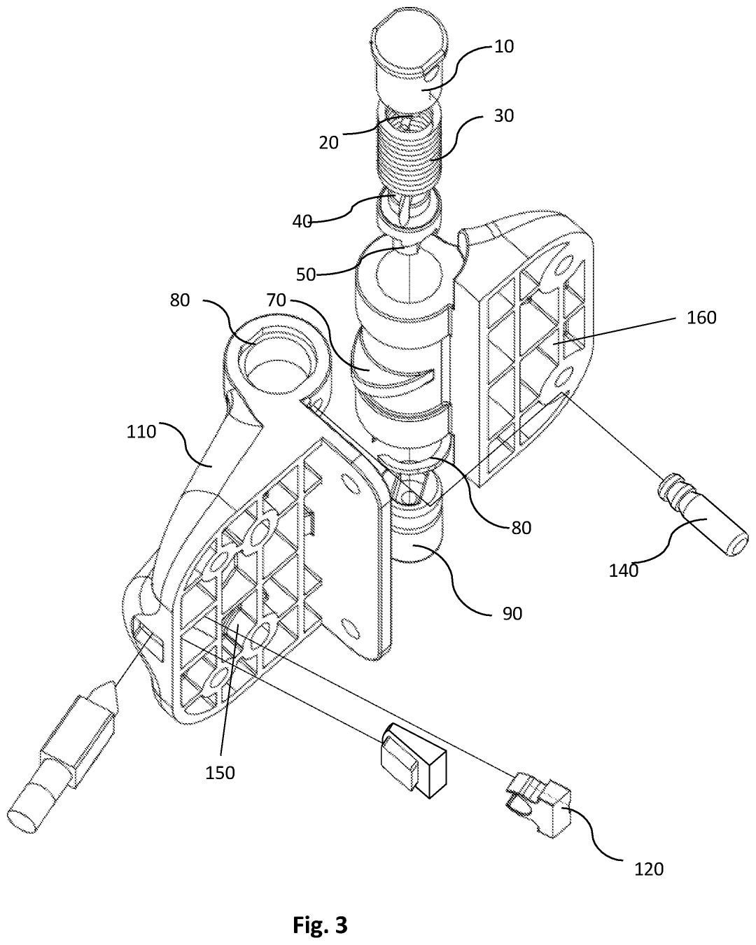

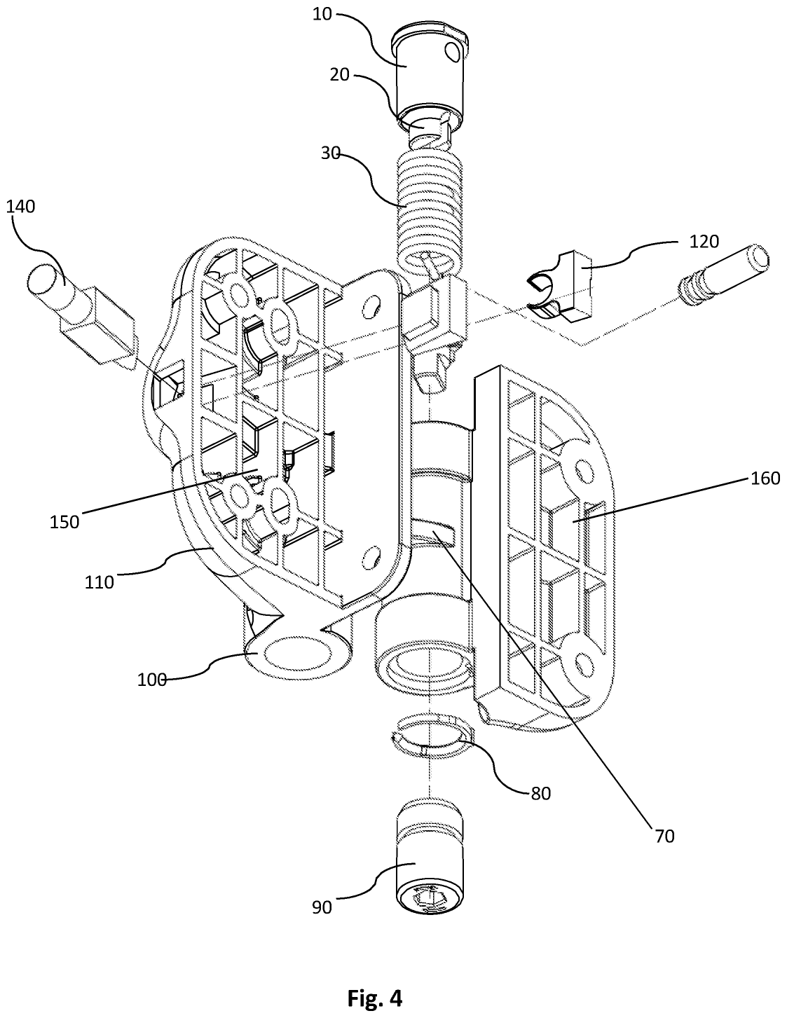

FIG. 1 and FIG. 2, according to an embodiment of the present invention, show exploded views of the hinge assembly. FIG. 3, according to an embodiment of the present invention, is another exploded view of the hinge assembly, also illustrating a pair of hinge leaves 150, 160. FIG. 4, according to an embodiment of the present invention, is another exploded view of the hinge, also illustrating the pair of hinge leaves 150, 160.

The hinge assembly 100 (or the hinge 100) is an improved hinge assembly 100 for providing soft-closing functionality in a gate. The hinge assembly 100 comprises a mounting element 110 having a top sleeve 80 and a bottom sleeve to receive an elongated hollow cylinder 60. An actuator 70 is provided on the outer surface of the elongated hollow cylinder 60. The mounting element 110 comprises a pair of hinge leaves 150, 160 that can be mounted on the gate and a corresponding gate post. The pair of hinge leaves 150, 160 move rotatably between an open position and a closed position to thereby open and close the gate. Thus, as the two leaves 150, 160 of the hinge mounting element 110 open and close, the gate or a door on which the hinge assembly 100 is mounted can be opened and close. The closing of the gate or door (not shown) is done automatically in a soft closing manner even if the door is shut with force. This helps restrict the banging of the doors when the doors are being shut. The hinge assembly 100 is assembled and secured using several fastening means 120 and fixing elements 140.

Further, a spring 30 and a tension screw 40 are adapted within the elongated hollow cylinder 60. The spring 30 is adapted to be adjusted using the tension screw 40 for altering spring tension. The actuator 70 absorbs the impact of the altering spring tension to thereby facilitate the soft-closing functionality while closing the gate. The actuator 70 of the elongated cylinder 60 is a ‘D’ shaped three-dimensional structure fixed on one side of the outside surface of the elongated hollow cylinder 60. The actuator 70 rests on a slit provided on one side of the mounting element 110. In one embodiment of the present invention, the actuator 70 rests on a slit provided on one leaf of the pair of hinge leaves 150, 160 of the mounting element 110.

According to an embodiment of the present subject matter, the hinge assembly further comprises a top cap 10 and a bottom cap 90 wherein the top cap 10 is adapted to engage a first end of the spring 30 to an engaging part 20 of the spring, and a second end of the spring 30 is engaged with one end of the tension screw 40 (i.e., the top part of the tension screw). The top cap 10 is adapted to provide an easy grip and is rotated to rotate the tension screw 40 for adjusting the tension.

According to an embodiment of the present subject matter, the elongated hollow cylinder 60 is installed on the mounting element 110 by using the top cap 10 adapted over the spring 30 and the bottom cap 90 adapted below another end of the tension screw 40. The top cap 10 passes through the top sleeve 80 and the bottom cap 90 passes through the bottom sleeve to install the elongated hollow cylinder 60 with the mounting element 110.

Referring now to FIGS. 1 and 2, the mounting element 110 is shown in its closed position, having first hinge leaf 150 and second hinge leaf 160. The hinge leaves 150, 160 have holes for receiving fastening means 120, for example bolts, to secure the first 150 and second hinge leaf 160 to a post and gate (not shown), respectively. It will also be appreciated that the hinge assembly 100 can be used with a door, with the first hinge leaf 150 being mountable to the door frame and the second hinge leaf 160 being mountable to the door. The holes are preferably of elongate form to allow some adjustment of the height of the hinge assembly 100 relative to the gate or door during installation. Once the hinge assembly 100 is positioned appropriately, a further fastener can advantageously be attached through hole to prevent movement of the hinge assembly 100 under the weight of the door or gate.

The mounting element 110 has a top sleeve 80 and a bottom sleeve 130 to receive the elongated hollow cylinder 60. The second hinge leaf 160 may rotate about the longitudinal axis of the mounting element 110 in order for the hinge 100 (or the hinge assembly 100) to move between the closed and open position. The second hinge leaf 160 has the pair of sleeves, the top sleeve 80 and the bottom sleeve 130, one at each end. As best shown in FIG. 4, the sleeves are adapted to receive the bottom cap 90, which is engaged with another end of the tension screw 40.

The spring 30 of the embodiments shown in the figures is a helical spring 30. The end piece also has a hole (not shown) to receive a pin or bolt (or any other suitable fastener). When the parts of the hinge assembly 100 are assembled, a pin or bolt passes through the hole in the bottom sleeve to secure the bottom cap 90 to the bottom sleeve 130. A first end of the helical spring 30 is thus fixed with respect to the end of the second hinge leaf. The second end of the helical spring 30 also has a flattened terminal segment (not shown) which fits into a slot (also not shown) in a tooth portion of the top cap 10, which also has a tool-receiving portion.

The opposite ends of the spring 30 are fixed with respect to respective hinge leaves, and rotational movement of the hinge leaves 150, 160 with respect to each other, for example by opening a gate to which the hinge 100 is attached, will tend to create a torsional restoring force to move the binge back to its original (i.e. closed) position.

The above-described hinge assembly is an improved hinge assembly that is designed to perform two kinds of functionalities. The first is to provide adjustments in the spring to increase or decrease the tension of the spring. The second functionality is to absorbs an impact of the altering spring tension to thereby facilitate the soft-closing functionality while closing the gate.

The term exemplary is used herein to mean serving as an example. Any embodiment or implementation described as exemplary is not necessarily to be construed as preferred or advantageous over other embodiments or implementations. Further, the use of terms such as including, comprising, having, containing and variations thereof, is meant to encompass the items/components/process listed thereafter and equivalents thereof as well as additional items/components/process.

Although the subject matter is described in language specific to structural features and/or acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

1. An improved hinge assembly for providing soft-closing functionality in a gate, the hinge assembly comprising:
a mounting element having a top sleeve and a bottom sleeve to receive an elongated hollow cylinder;
an actuator provided on an outer surface of the elongated hollow cylinder;
a spring and a tension screw adapted within the elongated hollow cylinder, the spring is adapted to be adjusted using the tension screw for altering spring tension;
wherein the actuator absorbs an impact of the altering spring tension to thereby facilitate the soft-closing functionality while closing the gate.

2. The improved binge assembly of claim 1, wherein the actuator of the elongated cylinder is a ‘D’ shaped three-dimensional structure fixed on one side of the outside surface of the elongated hollow cylinder.

3. The improved hinge assembly of claim 1, wherein the mounting element comprises a pair of hinge leaves that can be mounted on the gate and a corresponding gate post, the pair of hinge leaves move rotatably between an open position and a closed position to thereby open and close the gate.

4. The improved hinge assembly of claim 1, the actuator rests on a slit provided on one leaf of the pair of hinge leaves of the mounting element.

5. The improved hinge assembly of claim 1, further comprising a top cap and a bottom cap.

6. The improved hinge assembly of claim 5, wherein the top cap is adapted to engage a first end of the spring and a second end of the spring is engaged with one end of the tension screw.

7. The improved hinge assembly of claim 5, wherein the top cap is adapted to provide an easy grip and is rotated to rotate the tension screw for adjusting the tension.

8. The improved hinge assembly of claim 5, wherein the elongated hollow cylinder is installed on the mounting element by using the top cap adapted over the spring and the bottom cap adapted below another end of the tension screw.

9. The improved hinge assembly of claim 5, wherein the top cap passes through the top sleeve and the bottom cap passes through the bottom sleeve to install the elongated hollow cylinder with the mounting element.
